(19) United States
(12) Patent Application Publication
(10) Pub. No.: US 2008/0019799 A1
(43) Pub. Date: Jan. 24, 2008

(54) Fastener

(76) Inventors: Timothy D. Pearson, Palos Hills, IL (US); Christopher M. Pangallo, Chicago, IL (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/821,430

(22) Filed: Jun. 22, 2007

Related U.S. Application Data
(60) Provisional application No. 60/832,795, filed on Jul. 24, 2006.

(51) Int. Cl. F16B 21/00

(52) U.S. Cl. 411/512

(57) ABSTRACT

A fastener that can be used in various applications, that is more durable than known fasteners, and that increases the removal forces necessary to remove the fastener from the connecting substrate is made of a plastic material that defines a base and one or more fastening legs. The fastening legs extend outwardly from the base, are joined together at a common post and connect to the base at leg ends. Each of the fastening legs may have an angled surface at the leg ends and near the base. This angled surface provides a contact surface with the substrate to which the fastener is mounted and also increases the removal force needed to remove the fastener from the substrate. The leg ends are connected to the base and define a thickness at this connection point that provides sufficient flexibility for installation to the connecting substrate to prevent damage to the fastening legs so that greater extraction forces will be necessary to remove the fastener from the connecting substrate.

### CROSS REFERENCE TO RELATED APPLICATIONS

This Non-Provisional Application claims benefit to U.S. Provisional Application Ser. No. 60/832,795 filed Jul. 24, 2006.

### FIELD OF THE INVENTION

The present invention relates generally to retainers or fasteners, and more particularly, to plastic fasteners.

### BACKGROUND OF THE INVENTION

It is known that retainers or fasteners are used in various applications to perform various functions. It is further known that numerous types of retainers or fasteners are used in various automotive applications. Specifically, plastic fasteners are used in the automotive industry and in other industries where an object must be secured to another medium or substrate.

Rigid plastic fasteners are more easily damaged during installation of the fastener into a hole or opening in the substrate. One common problem with plastic fasteners is that the legs of the plastic fastener may be damaged because the connection point between the legs and the body of the fastener is not sufficiently flexible and consequently the legs of the fastener do not flex inwardly enough and therefore may fail at the connection point or otherwise become damaged when being inserted into the hole of the substrate. Moreover, if the fastening legs are too rigid, the engaging surfaces of the fastening legs may be damaged or scraped off during installation. If the engaging surfaces of the fastening legs are undesirably damaged, the fastener will have reduced retention forces, thereby allowing the fastener to be more easily removed from the substrate.

The present invention provides a fastener and in particular a plastic fastener which is not damaged during installation and is not easily removed.

### SUMMARY OF THE INVENTION

The present invention is directed to, in an exemplary embodiment, a fastener that can be used in various applications, that is more durable than known fasteners, is more resistant to damage during installation of the fastener and that increases the removal forces necessary to remove the fastener from the connecting substrate.

In an exemplary embodiment, the fastener is made of a plastic or elastomeric material that defines a base and one or more fastening legs. The fastening legs extend outwardly from the base, are joined together at a common post and connect to the base at leg ends. Each of the fastening legs may have an angled surface at the leg ends and near the base. This angled surface provides a contact surface with the substrate to which the fastener is mounted and also increases the removal force needed to remove the fastener from the substrate. The leg ends are connected to the base at connection points that define a thickness sufficient to prevent shearing or stretching at the connection points yet provides the desired flexibility for the fastening legs to prevent damage to other parts of the fastener, such as the angled surfaces, during installation to the substrate.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is an isometric view of an exemplary embodiment of the fastener with a base.

FIG. 2 is a side view of an exemplary fastener of the invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE EMBODIMENTS

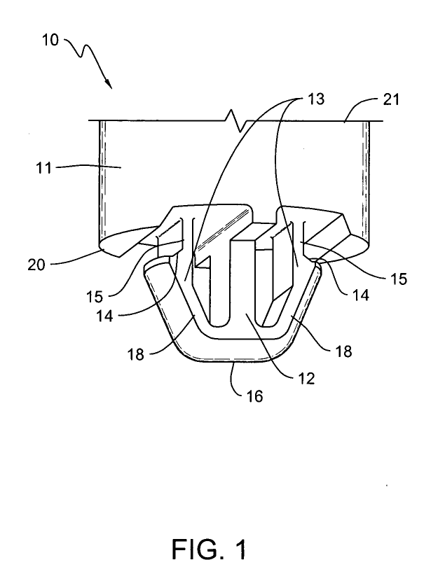

The present invention may be embodied in many forms. In one exemplary embodiment depicted in FIG. 1, the present invention is directed to a fastener 10 with a base 11 defining a first side 20 and a second side 21. The fastener base 11 may define numerous configurations including the illustrated round base depicted in FIG. 1. The fastener 10 further includes one or more fastening legs 13 joined to a common support post 12 which extends outwardly from the first side 20 of the base 11.

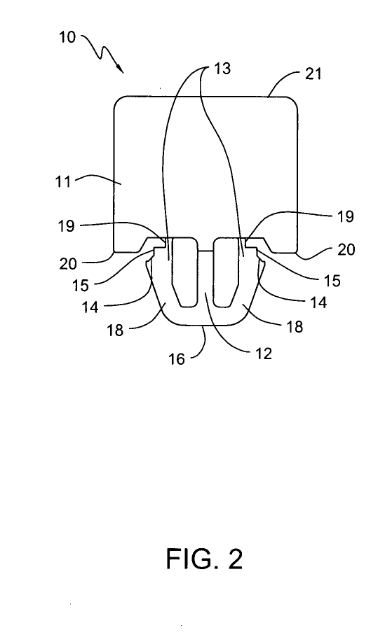

In one exemplary embodiment, the one or more fastening legs 13 extend outwardly and angularly from a common end 16 of the support post 12. The legs 13 define leg ends 15 that are joined to the first side 20 of the base 11 at connection points 19 (FIG. 2). The ends 15 at connection points 19 may extend substantially perpendicularly from the first side 20 of the base 11. At each connection point 19 where each end 15 joins with the base 11, the ends are sufficiently flexible to allow the legs 13 to flex inwardly during installation of the fastener to an opening in a substrate so as to prevent damage to the legs 13 during such installation. The leg ends at connection points 19 are, however, also sufficiently thick to prevent undesirable shearing or stretching at the connection with the base 11. The leg ends at connection points 19 further serve to control the flexing of the legs 13 to improve the retention of the fastener 10 after the fastener 10 is mounted in the opening in the substrate. This is accomplished by the connection of the legs 13 to the base 11 which will prevent excessive inward flexing of the legs. The reduced connection point thickness allows for installation without damage and, therefore, improved removal force values.

As shown in FIG. 2, at this connection point 19, the thickness of the legs 13 may be reduced as compared to the thickness of the legs at other portions of the legs. This reduced thickness provides the desired flexibility of the fastening legs 13 during installation of the fastener 10 to the opening in the substrate to prevent damage to other portions of the fastening legs 13, such as at the angled surfaces 14 and tips thereof formed on the fastening legs 13. The fastener 10 may be made of any suitable material. In one exemplary embodiment, the fastener 10 may be made of plastic. As used herein, the term “plastic” broadly refers to any known material that is capable of being molded and may include any known elastomer or polymer, whether hard or soft.

The thickness of the fastening legs 13 at leg portion 18 and near the common end 16 is greater than the thickness of the legs at connection points 19. The reduced thickness provides flexibility at this point to permit the legs 13 to flex during installation to a connecting substrate. In one embodiment, the fastening legs 13 may further define at least one angled surface 14 that acts as a contact surface for the connecting substrate when the fastener 10 is inserted into the opening in the connecting substrate. By reducing the installation forces through the reduced connection points, the angled surface 14 is less likely to be damaged during installation, thereby ensuring the desired extraction forces that would be necessary to remove the fastener from the mating substrate.

Known fasteners include an angled surface; however, known fasteners may shear or stretch (or material may scrape off or otherwise become displaced) from the angled surface during the installation of the fastener to the substrate. This damage occurs if the thickness of the leg ends that connect to the base are too thick and rigid, and not sufficiently flexible to permit bending of the fastening legs. With the present invention, there is sufficient flexibility at the leg ends and specifically at connection points 19 (which illustrates a reduced thickness relative to other portions of the fastening legs) to prevent or minimize damage to the legs at the angled surface 14. The thickness of the fastening legs 13 at connection points 19 provides the desired flexibility and structural integrity of the fastening legs at this point and reduces the likelihood of shearing or damage to the angled surface 14. By preventing this damage, the invention ensures greater extraction forces will be necessary to remove the fastener 10 from the connecting substrate.

It should be understood that the configuration of the support post 12 and fastening legs 13 may vary. For example, if one fastening leg 13 is desired, for instance, in a vertical mounting application, the support post 12 may be configured such that during installation into the opening in the substrate, the post 12 will contact one side of the opening while the fastening leg 13 will mount to the opposing side of the substrate opening. In this embodiment, the support post 12 and fastening leg 13 will define a J-shaped configuration, with the fastening leg 13 flexing during installation as described above. It should also be understood that the configuration of the leg ends may vary and yet provide the desired flexibility at the connection points. It should further be understood that the thickness of the leg ends 15 and at connection points 19 may vary depending on the material used and the hardness (durometer) of the material and yet provide the desired durability and flexibility at this point as well as the desired insertion and extraction forces that are required to remove the fastener.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A fastener comprising:
a fastener base defining a first side and a second side;
a support post extending outwardly from the first side of the base; and
at least one fastening leg having a first end and extending outwardly from the post at the first end, the at least one fastening leg also having a second end that is joined to the first side of the base, the at least one fastening leg defining a thickness at the second end that is less than the thickness of the fastening leg at the first end, the at least one fastening leg defining an angled surface located between the second end and the first end.

2. The fastener of claim 1, wherein the fastener is made of plastic.

3. The fastener of claim 1, wherein the fastener base is round.

4. The fastener of claim 1, wherein the at least one fastening leg extends angularly outwardly from the post at the first end.

5. The fastener of claim 4, wherein the at least one fastening leg at the second end extends substantially perpendicular from the first side of the base.

6. A fastener comprising:
a fastener base defining a first side and a second side;
a support post extending outwardly from the first side of the base; and
at least one fastening leg extending outwardly from the post and defining an end that is joined to the first side of the base, the end extending substantially perpendicularly from the first side of the base, the at least one fastening leg defining a thickness at the end that is less than the thickness of the fastening leg extending between the end and the support post, the at least one fastening leg defining an angled surface near the end.

7. The fastener of claim 6, wherein the fastener is made of plastic.

8. The fastener of claim 6, wherein the fastener base is a clip.

9. The fastener of claim 6, wherein the at least one fastening leg extends angularly outwardly from the post.

10. The fastener of claim 9, wherein the at least one fastening leg is joined at a common end to the post.
